(19) United States
(12) Patent Application Publication
(10) Pub. No.: US 2026/0310855 A1
(43) Pub. Date: Oct. 8, 2026

(54) Efficiency-Aware Performance Bounds in SoC Design

(71) Applicant: Google LLC, Mountain View, CA (US)

(72) Inventors: Mohsen Heidarinejad, San Jose, CA (US); Farid Kenarangi, Milpitas, CA (US); Arpit Mittal, San Jose, CA (US); Vinu Vijay Kumar, Belmont, CA (US)

(73) Assignee: Google LLC, Mountain View, CA (US)

(21) Appl. No.: 19/169,690

(22) Filed: Apr. 3, 2025

(51) Int. Cl. G06F 30/27; G06F 30/337; G06F 119/06; G06F 119/08

(52) U.S. Cl. CPC G06F 30/27; G06F 30/337; G06F 2119/06; G06F 2119/08

(57) ABSTRACT

Techniques and apparatuses are described for implementing efficiency-aware performance bounds in system-on-chip (SoC) design. In aspects, a decision module receives one or more target values from a policy coordinator, the one or more target values based on one or more intellectual property (IP) parameters of one or more IP agents. In further aspects, the decision module receives one or more performance state recommendations from one or more processing modules. In some examples, the decision module generates a performance state change command, the performance state change command configured to change the one or more IP performance states of the one or more IP agents. The decision module outputs the performance state change command to the one or more IP agents. In this way, a system-on-chip can dynamically manage multiple operations concerns for the one or more processors, such as balancing performance, temperature, and power concerns to realize a tailored user experience.

### BACKGROUND

Original equipment manufacturers (OEMs) of electronic devices using one or more intellectual property (IP) agents (e.g., multi-core processors) on a system-on-chip (SoC) architecture face the challenge of dynamically balancing IP agent parameters, such as performance, temperature, and power. For example, a user may want to increase a performance of their computing device so they can play video games. To meet the computational demands, the system may increase the processor's frequency and voltage to achieve the required performance. However, this may lead to significantly higher power consumption, which, in turn, generates excess heat/temperature. This may trigger thermal throttling, which introduces severe performance degradation, causing lag, input delays, and a poor user experience. A decoupled approach cannot capture these interactions effectively, leading to higher risks of performance degradation. Furthermore, deploying adaptive and/or general dynamic architectures is expensive in a computationally resource-constrained SoC. Efficiency-aware performance bounds in SoC design is needed to ensure a tailored user experience.

### SUMMARY

Techniques and apparatuses are described for implementing efficiency-aware performance bounds in system-on-chip (SoC) design. In aspects, a decision module receives one or more target values from a policy coordinator, the one or more target values based on one or more intellectual property (IP) parameters of one or more IP agents, the one or more IP parameters based on one or more IP performance states of the one or more IP agents. In further aspects, the decision module receives one or more performance state recommendations from one or more processing modules, the one or more performance state recommendations configured to alter the one or more IP performance states. In some examples, the decision module generates, based on the one or more target values and the one or more performance state recommendations, a performance state change command, the performance state change command configured to change the one or more IP performance states of the one or more IP agents. The decision module, in aspects, outputs the performance state change command to the one or more IP agents. In this way, an SoC can dynamically manage multiple operations concerning the one or more processors, such as balancing performance, temperature, and power concerns to realize a tailored user experience.

Aspects described below include a method performed by an SoC, the method including receiving, by a decision module and from a policy coordinator, one or more target values, the one or more target values based on one or more IP parameters of one or more IP agents, the one or more IP parameters based on one or more IP performance states of the one or more IP agents. The method further includes receiving, by the decision module and from one or more processing modules, one or more performance state recommendations, the one or more performance state recommendations configured to alter the one or more IP performance states. The method further includes generating, based on the one or more target values and the one or more performance state recommendations, a performance state change command, the performance state change command configured to change the one or more IP performance states of the one or more IP agents. The method further includes outputting the performance state change command to the one or more IP agents.

Aspects described below also include an SoC including one or more processors, one or more process modules, and a memory storing instructions that, when accessed by the one or more processors, cause the one or more processors to perform any one of the described methods.

Aspects described below also include a non-transitory, computer-readable medium that, when accessed by one or more processors, causes the one or more processors to perform any one of the described methods.

Aspects described below also include a computer programming product that, when accessed by one or more processors, causes the one or more processors to perform any one of the described methods.

### BRIEF DESCRIPTION OF THE DRAWINGS

Apparatuses and techniques for implementing efficiency-aware performance bounds in SoC design are described with reference to the following drawings. The same numbers are used throughout the drawings to reference like features and components:

FIG. 1 illustrates an example environment in which efficiency-aware performance bounds in SoC design can be implemented;

FIG. 2 illustrates an example implementation of a computing device that can implement aspects of efficiency-aware performance bounds in SoC design;

FIG. 3 illustrates an example implementation of efficiency-aware performance bounds in SoC design;

FIG. 4 illustrates example modules for efficiency-aware performance bounds in SoC design;

FIG. 5 illustrates an example implementation of efficiency-aware performance bounds in SoC design;

FIG. 6 illustrates an example of machine-learning (ML), as outlined in this disclosure;

FIG. 7 illustrates an example ML architecture for efficiency-aware performance bounds in SoC design;

FIG. 8 illustrates an example method for performing efficiency-aware performance bounds in SoC design;

FIG. 9 illustrates another example method for efficiency-aware performance bounds in SoC design;

FIG. 10 illustrates another example method for efficiency-aware performance bounds in SoC design; and

FIG. 11 illustrates another example method for efficiency-aware performance bounds in SoC design.

### DETAILED DESCRIPTION

An electronic device can be implemented with a system-on-chip (SoC), which can provide many features of the electronic device. An example SoC can include one or more intellectual property (IP) agents. The one or more IP agents, for example, can include a central processing unit (CPU), a graphics processing unit (GPU), a tensor processing unit (TPU), a neural processing unit (NPU), an associative processing unit (APU), a field-programmable gate array (FPGA), a visual processing unit (VPU), a digital signal processor (DSP), a memory controller, a universal serial bus (USB) controller, a peripheral component interconnect express (PCIe) controller, an Ethernet controller, an Inter-Integrated Circuit (I2C) controller, a Serial Peripheral Interface (SPI) controller, a Direct Memory Access (DMA) controller, a WiFi™ controller, a Bluetooth™ controller, a hardware security module (HSM), a random number generator (RNG), an analog-to-digital converter (ADC), a digital-to-analog converter (DAC), a sensor, an audio processor, a video processor, a cryptographic accelerator, or an image sensor interface.

Original equipment manufacturers (OEMs) of electronic devices using such SoCs, including those with multi-core processors, face the challenge of dynamically balancing IP agent parameters (performance, temperature, power, etc.). Consider a user of a computing device using the computing device for video calling. The user may expect a certain level of performance, but, if the computing device allocates too many resources to the computing device, an experience of the user may be negatively affected. For example, the computing device can drain a battery too quickly, produce too much heat, or operate the CPU at too high of a temperature. Consider a second use case of the computing device, where the user plays a high-performance video game. In this situation, the user requires maximum performance at the expense of other parameters (e.g., battery life), but heat concerns persist. A dynamic management including efficiency optimization is needed to ensure a tailored user experience.

A policy coordinator can be used to manage power, performance, and thermal conditions across one or more IP agents within an SoC. However, the policy coordinator can, in some instances, introduce unwanted conditions for the user experience. For example, the policy coordinator may attempt to optimize power efficiency in a manner that results in abrupt adjustments to performance state across multiple IP agents. These sudden adjustments may negatively impact the user experience. For example, the policy coordinator may detect a rise in temperature and, in response, aggressively throttle the CPU and/or the GPU to mitigate overheating. However, this change in performance state may be excessively abrupt, causing a noticeable slowdown in performance. Such a slowdown can result in undesirable conditions, such as dropped video frames, input lag, and system stuttering, ultimately degrading the overall user experience.

In aspects, the policy coordinator can determine a set of constraints (e.g., target values) for performance, power, and temperature. For example, the policy coordinator can specify a power target value. A power optimizer module, in examples, can use a power consumption model to calculate a performance state needed to meet the power target value. The power consumption model can be expressed as the sum of dynamic power, P_{D}, and leakage power, P_{L}. Dynamic power and leakage power can be modeled as seen in Equations 1 and 2 below. Equation 3 shows the sum of the dynamic power and leakage power as the total power, P,

$${P}_{D} = α \cdot {V}^{2} \cdot v \qquad Eq . 1$$

$${P}_{L} = {V}^{1.6} \cdot {2}^{T / 20} \qquad Eq . 2$$

$$P = α \cdot {V}^{2} \cdot v + {V}^{1.6} \cdot {2}^{T / 20} \qquad Eq . 3$$

In Eqs. 1-3, α is an activity factor, v is voltage of a system, v is frequency of a system, and T is temperature of a system. The activity factor, in examples, can be a fixed parameter that does not depend on the operation point of an IP agent.

The power optimizer module can determine a maximum performance state of the system (e.g., an upper bound) by using the following equation:

$${P}_{T} = α \cdot {V}^{2} \cdot v + {V}^{1.6} \cdot {2}^{T / 20} \qquad Eq . 4$$

In Eq. 4, P_{T} is the power target value. The power optimizer module can perform a fast sweep of a dynamic voltage and frequency scaling (DVFS) table to find the highest DVFS point that can satisfy the equation. Efficiency-aware performance bounds in SoC design may determine that the power consumption cannot exceed a certain value and may use this to determine the power target value. Given the power target value from the policy coordinator and a current temperature of the system, the power optimizer module can calculate the voltage and frequency values that solve the equation. This target-value-based approach can ensure efficient operation of the computing device that maintains performance while balancing power limits.

The present document details the use of a decision module, which can enable selection between multiple performance state recommendations. In the context of this document, the term performance state recommendations is defined as data configured to change the performance state of an IP agent. For example, if the CPU is determined to be in a performance state such that the CPU is operating at too high of a temperature, the performance state recommendation can include instructions to change a voltage, frequency, and/or operation point of the CPU. The performance state recommendation can be configured to account for and/or affect any parameter of the IP agent, examples of which shall be illustrated further on in the document.

The decision module receives the performance state recommendation from the policy coordinator. In aspects, the decision module also receives a performance state recommendation from a module (including receipt of a plurality of performance state recommendations from a plurality of modules). The decision module, in aspects, generates a performance state change command based on the received performance state recommendations. In some examples, the performance state change command is one of the performance state recommendations. For example, the decision module can be configured to operate the SoC in a default safe manner, selecting the performance state recommendation with the most conservative operating conditions for the one or more IP agents as the performance state change command. For example, the selection can proceed by comparing the performance state recommendations with one or more threshold values, or by comparing the performance state recommendations to one another.

In some examples, the performance state change command is configured to change an initialization of the policy coordinator. In some examples, the operation of the SoC by the decision module using the performance state change command can be accomplished by the initialization of the policy coordinator. In such examples, the policy coordinator can be the agent that interacts directly with the one or more IP agents and/or the SoC. For the purposes of this disclosure, such an operation of the policy coordinator, which is predicted by receipt of the performance state change command from the decision module, is implied directly or indirectly when reference is made to one or more IP agents and/or the SoC being influenced, controlled, or otherwise changed by the performance state change command of the decision module.

The use of the decision module, in aspects, allows for a nuanced performance state change for the IP agent. Multiple performance state recommendations can be considered, as well as multiple operating conditions, targets, practices, etc. For example, the decision module can operate using a target of maximum performance without risking device damage. In another example, the decision module can operate using a target of maximum battery savings while maintaining a minimum acceptable performance. In still another example, the decision module can operate using a target of a smooth user experience (e.g., minimized lag, no frame drops in a video, etc.).

### Operating Environment

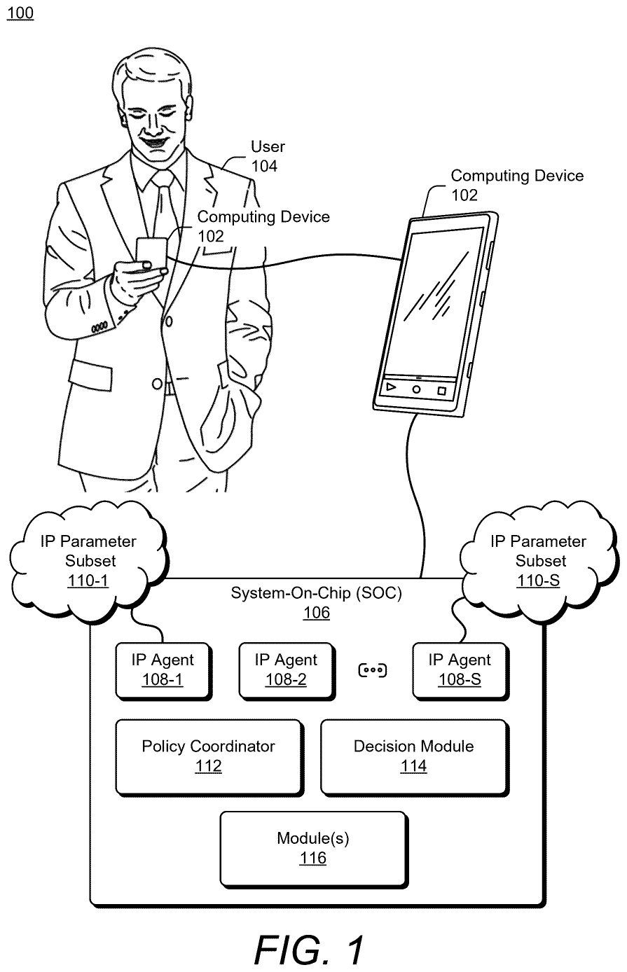

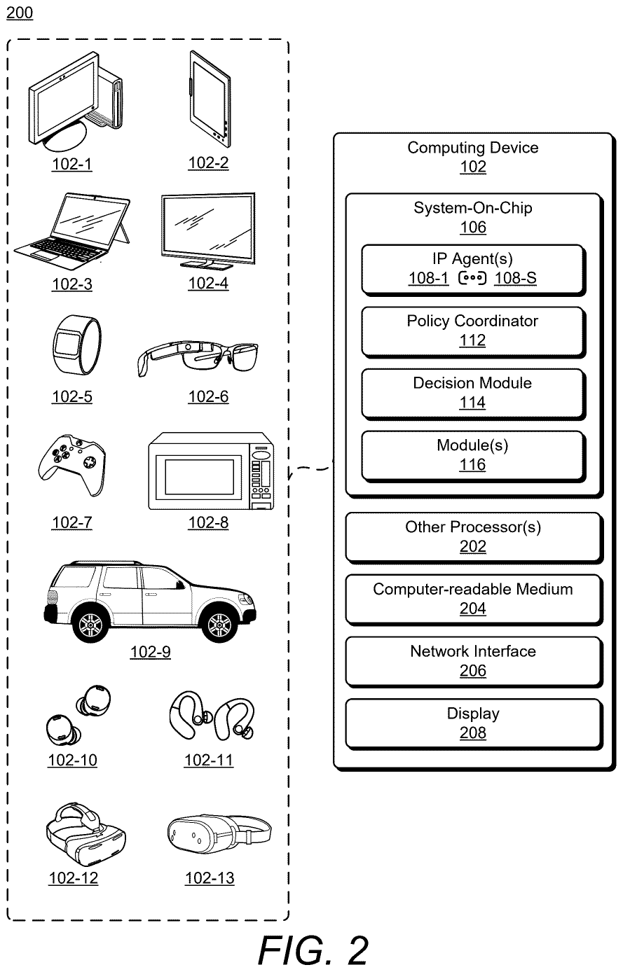

FIG. 1 illustrates an example environment 100 in which efficiency-aware performance bounds in SoC design can be implemented. In the example environment 100, a computing device 102 provides features and/or services for a user 104. Although depicted as a smartphone, the computing device 102 can include other types of devices, including those described with respect to FIG. 2. The computing device 102 includes at least one SoC 106. The SoC 106 can be implemented with electronic circuitry, a microprocessor, memory, input-output (I/O) control logic, communication interfaces, firmware, and/or software useful to provide functionalities of the computing device 102.

The SoC 106 includes one or more IP agents 108-1, 108-2 . . . 108-S, where S represents a positive integer. The one or more IP agents 108 can also be referred to as intellectual-property blocks (IP blocks), intellectual-property cores, etc. The one or more IP agents 108, for example, can be one or more of a central processing unit (CPU), a graphics processing unit (GPU), a digital signal processor (DSP), a memory controller, a universal serial bus (USB) controller, a peripheral component interconnect express (PCIe) controller, an Ethernet controller, an Inter-Integrated Circuit (I2C) controller, a Serial Peripheral Interface (SPI) controller, a Direct Memory Access (DMA) controller, a WiFi™ controller, a Bluetooth controller, a hardware security module (HSM), a random number generator (RNG), an analog-to-digital converter (ADC), a digital-to-analog converter (DAC), a sensor, an audio processor, a video processor, a cryptographic accelerator, or an image sensor interface.

The one or more IP agents 108 have one or more IP parameter subsets 110. For example, the IP agent 108-1 has the IP parameter subset 110-1. The one or more IP parameter subsets 110 can affect a condition of the computing device 102, the SoC 106, or other related components. Examples of the one or more IP parameters 110 pertaining to an IP agent 108 of a CPU include a clock frequency, a cache size and/or configuration (e.g., L1, L2, L3), an instruction set architecture (ISA), a number of cores, a voltage, a pipeline depth, power management settings, read/write registers, control bits, or status flags. Examples of the one or more IP parameters 110 pertaining to an IP agent 108 of a GPU include a number of shader cores, a memory bandwidth, texture mapping units, a rendering pipeline configuration, clock frequencies, read/write registers, a voltage, or memory-mapped control. Examples of the one or more IP parameters 110 pertaining to an IP agent 108 of a DSP include a multiply-accumulate (MAC) unit count, a memory architecture, a clock frequency, data precision, instruction set extensions, read/write registers, or memory mapped control.

Examples of the one or more IP parameters 110 pertaining to an IP agent 108 of a memory controller include a memory type (double data rate (DDR) 4, DDR5, etc.), a memory clock frequency, timing parameters (latency, refresh rates), error correction (ECC) settings, a memory bus width, read/write registers, or control bits. Examples of the one or more IP parameters 110 pertaining to an IP agent 108 of a USB controller include a USB version (2.0, 3.0, etc.), endpoint configuration, transfer modes (bulk, interrupt, isochronous, etc.), power management settings, read/write registers, or endpoint buffers. Examples of the one or more IP parameters 110 pertaining to an IP agent 108 of a PCIe Controller include a PCIe generation (3.0, 4.0, 5.0, etc.), a lane width, root complex or endpoint configuration, DMA settings, link speeds, a configuration space, or registers.

Examples of the one or more IP parameters 110 pertaining to an IP agent 108 of an Ethernet controller include an Ethernet speed (10/100/1000 Mbps, etc.), a MAC address, flow control settings, interrupt settings, read/write registers, or packet buffers. Examples of the one or more IP parameters 110 pertaining to an IP agent 108 of an I2C controller include a clock speed, an address configuration, a master/slave mode, read/write registers, or data buffers. Examples of the one or more IP parameters 110 pertaining to an IP agent 108 of an SPI controller include a clock speed, a clock polarity and/or phase, a data frame size, a master/slave mode, read/write registers, or data buffers.

Examples of the one or more IP parameters 110 pertaining to an IP agent 108 of a DMA controller include source and destination addresses, a transfer size, a transfer mode (memory-to-memory, peripheral-to-memory, etc.), or read/write registers or transfer descriptors. Examples of the one or more IP parameters 110 pertaining to an IP agent 108 of a WiFi™ controller include wireless standards (802.11 a/b/g/n/ac/ax), frequency bands, security protocols, power settings, or read/write registers or firmware parameters. Examples of the one or more IP parameters 110 pertaining to an IP agent 108 of a Bluetooth controller include a Bluetooth version (4.0, 5.0, etc.), a profile support, a transmit power, connection parameters, or read/write registers or firmware parameters.

Examples of the one or more IP parameters 110 pertaining to an IP agent 108 of an HSM include cryptographic algorithm support, a key storage, secure boot settings, an access control, or read/write secure registers or cryptographic functions. Examples of the one or more IP parameters 110 pertaining to an IP agent 108 of an RNG include a random number generation algorithm, an output data rate, a statistical quality, or read output data registers or status registers. Examples of the one or more IP parameters 110 pertaining to an IP agent 108 of an ADC include a resolution, a sampling rate, an input voltage range, a channel selection, or read/write control registers or data registers.

Examples of the one or more IP parameters 110 pertaining to an IP agent 108 of a DAC include a resolution, an output voltage range, an update rate, a channel selection, or read/write control registers or data registers. Examples of the one or more IP parameters 110 pertaining to an IP agent 108 of a sensor include a measured temperature, acceleration values, lux values, a resolution, a sensitivity, or read data registers. Examples of the one or more IP parameters 110 pertaining to an IP agent 108 of an audio processor include a codec support, a sampling rate, a volume control, equalizer settings, or read/write registers or audio buffers.

Examples of the one or more IP parameters 110 pertaining to an IP agent 108 of a video processor include a codec support (H.264, H.265, etc.), a resolution, a frame rate, a color space conversion, or read/write registers or video buffers. Examples of the one or more IP parameters 110 pertaining to an IP agent 108 of a cryptographic accelerator include an algorithm support (AES, RSA, etc.), a key size, an operating mode, read/write registers, key buffers, or data buffers. Examples of the one or more IP parameters 110 pertaining to an IP agent 108 of an image sensor interface include a pixel format, a frame rate, an exposure control, a gain control, or read/write registers or image data buffers.

For example, the one or more IP agents 108 can produce heat (e.g., too high of an operating temperature) as one of the IP parameters of the one or more IP parameter subsets 110. The heat can contribute to increasing an internal temperature of the computing device 102. Left unchecked, the accumulation of heat within the computing device 102 can result in a high temperature that can damage the SoC 106, can damage other components of the computing device 102, and/or can reduce a reliability of the computing device 102. In some cases, the high temperature can cause the computing device 102 to become unsafe for the user 104 to operate.

In another example, the one or more IP agents 108 can have a performance output as one of the operation parameters of the one or more operation parameter subsets 110. In an example where the user 104 is engaging with the computing device 102 in such a way that minimal performance is required (e.g., a low power state, using the computing device 102 as a music player), if the performance output is higher than required, the user 104 may experience unwanted effects, such as a decreased battery life. In an example where the user 104 is engaging with the computing device 102 in such a way that high performance is required (e.g., active mapping, a video game), if the performance output is lower than required, the user 104 may experience unwanted conditions, such as lag, skipped frames, etc.

To avoid these situations, the SoC 106 includes a policy coordinator 112. The policy coordinator 112, in aspects, controls one or more performance states pertaining to the one or more IP agents 108. For example, consider the example of the CPU as the one or more IP agents 108. The CPU can have parameters such as the voltage and the frequency. The policy coordinator 112 can, in some examples, include threshold parameters for the CPU. For example, the threshold parameters can include a maximum operating temperature, a performance minimum, etc. Suppose an application accessed by the user 104 of the computing device 102 sets the performance minimum at a relatively high point and the CPU is operating at a temperature much lower than a safe temperature threshold. The policy coordinator 112 can, in such an example, send a performance state change command to the CPU to increase performance.

In some examples, changes to the one or more IP agents 108 made by the policy coordinator 112 can be abrupt. For example, consider the audio processor as the one or more IP agents 108 with the corresponding IP parameter subset 110 including the volume control. In some examples, the policy coordinator 112 a parameter calling for a maximum volume to increase due to increased ambient noise. If the policy coordinator 112 increases the overall volume suddenly, this can lead to a negative user experience.

In aspects, a decision module 114 is included on the SoC 106 to ensure smooth operation of the policy coordinator 112. The decision module 114, in some examples, can choose whether or how to employ the performance state change command from the policy coordinator 112. In aspects, one or more modules 116 are included on the SoC 106. The one or more modules 116 can, for example, provide one or more module performance state change commands to the decision module 114. In some examples, the decision module 114 can select from the performance state change command and the module performance state change commands to generate a performance state change command. In other examples, the decision module 114 can generate the performance state change command based on one or more of the performance state change commands and the one or more module performance state change commands. In some examples, the decision module 114 can modify the performance state change command by comparing it to a threshold value for a rate of change for operational optimization, user experience, or any other thing pertaining to smooth operation of the computing device 102 and/or the SoC 106.

The components of the SoC 106 (e.g., the one or more IP agents 108, the one or more modules 116) can alternatively be implemented within other types of integrated circuits or embedded systems, such as a microchip, an application-specific integrated circuit (ASIC), an application-specific standard product (ASSP), a digital signal processor (DSP), a programmable SoC (PSoC), a system-in-package (SiP), a controller, and so forth. The computing device 102 is further described with respect to FIG. 2.

### Example Computing Device

FIG. 2 illustrates an example implementation 200 of the computing device 102 of FIG. 1. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a computing appliance 102-8, a vehicle 102-9, earbuds 102-10 (e.g., true-wireless earbuds, wired earbuds), hearing aids 102-11, a virtual-reality (VR) headset 102-12, and an augmented-reality (AR) headset 102-13. Other devices may also be used, including a home service device, a smart speaker, a smart thermostat, a baby monitor, a Wi-Fi™ router, a drone, a trackpad, a drawing pad, a netbook, an e-reader, a home automation and control system, a wall display, or another computing device. Note that the computing device 102 can be wearable, non-wearable but mobile, or relatively immobile (e.g., desktops and appliances). The computing device 102 includes the SoC 106 of FIG. 1. The SoC 106 includes the one or more IP agents 108-1 to 108-S, the policy coordinator 112, the decision module 114, and the one or more modules 116, as described in FIG. 1.

The computing device 102 also includes, in some examples, at least one other processor 202 and at least one computer-readable medium 204 (e.g., non-transitory computer-readable medium). The computer-readable medium 204 can include memory media and/or non-transitory storage media. An operating system (not shown) embodied as computer-readable instructions on the computer-readable medium 204 can be executed by the at least one other processor 202 and/or the one or more IP agents 108. In some examples, the policy coordinator 112, the decision module 114, at least one of the one or more modules 116, or a combination of these reside on the computer-readable medium 204.

The computer-readable medium 204 can include one or more applications. Execution of the application(s) can, in some examples, involve operating the one or more IP agents 108. Example applications can include a messaging application, an application that plays videos, a navigation application, or a gaming application. Different applications can have different performance requirements and cause the one or more IP agents 108 (e.g., the CPU, the GPU) to operate with different workloads. For example, consider the one or more IP agents 108 being the CPU. The messaging application can require less processing power from the CPU than the gaming application. In some examples, different applications can have other usage requirements, such as a core count of the CPU, usage of the CPU and the GPU concurrently, access to the RNG, etc. In general, each application can be associated with particular performance state characteristics (e.g., relating to the one or more IP parameter subsets 110), which, in some examples, represent usage of a number of resources of the SoC 106. Consider, for example, the performance state characteristic being a temperature of the CPU. This temperature generation impacts an overall temperature of the computing device 102.

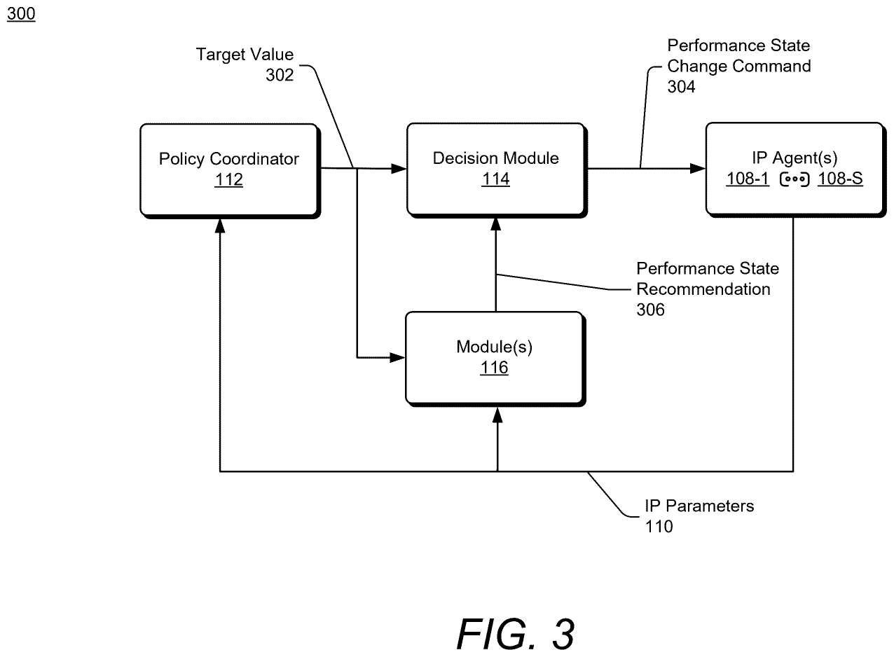

The computing device 102 can additionally include a network interface 206 for communicating data over wired, wireless, or optical networks. For example, the network interface 206 may communicate data over a local-area network (LAN), a wireless local-area network (WLAN), a personal-area network (PAN), a wide-area network (WAN), an intranet, the Internet, a peer-to-peer network, a point-to-point network, a mesh network, Bluetooth™, and the like. The computing device 102 may also include a display 208. An example implementation of efficiency-aware performance bounds in SoC design with respect to the policy coordinator 112, the decision module 114, and the one or more modules 116 is further described with respect to FIG. 3.

### Dynamic Control for a System-on-Chip

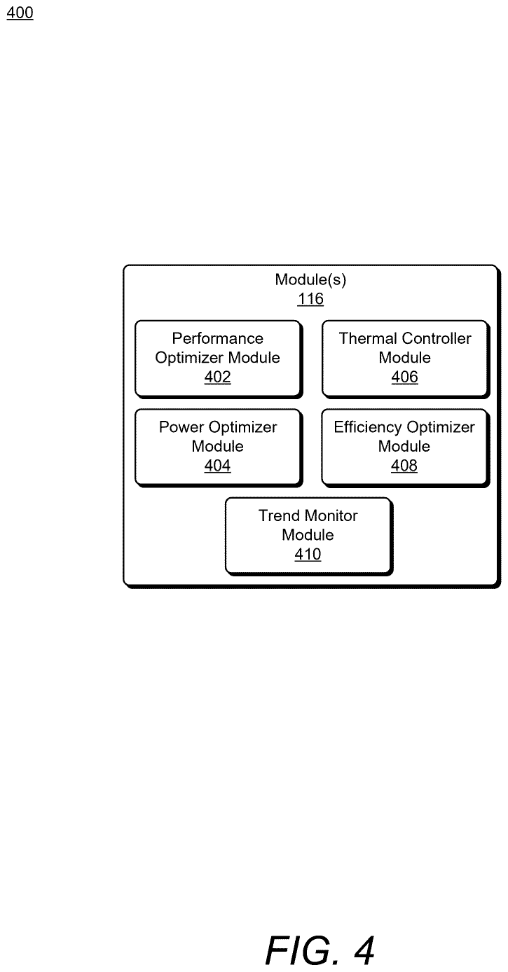

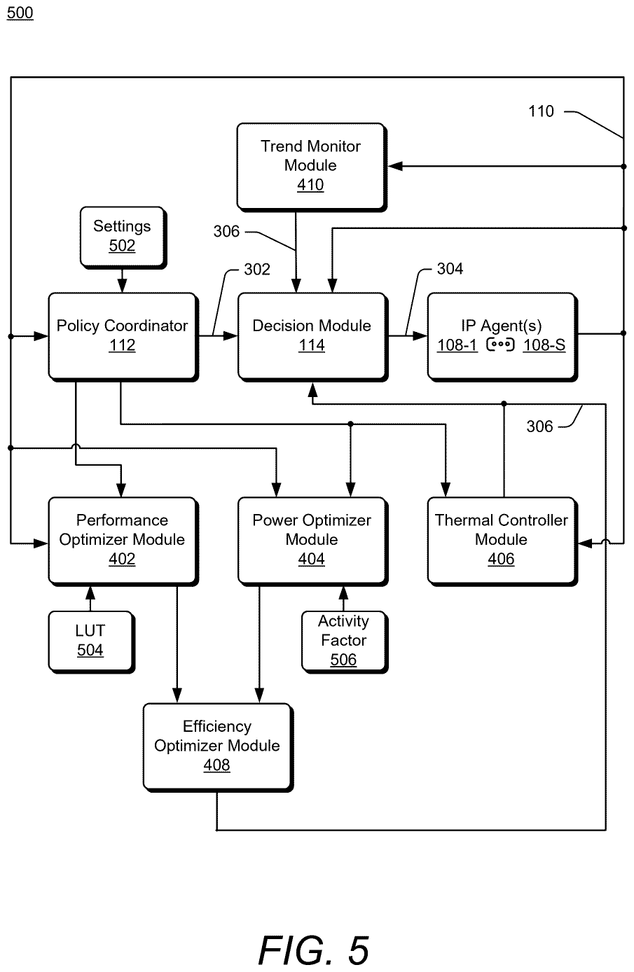

FIG. 3 illustrates an example implementation 300 of efficiency-aware performance bounds in SoC design. In aspects, the policy coordinator 112 (described with respect to FIG. 1) outputs a target value 302 to the decision module 114. The decision module 114 outputs a performance state change command 304 to the one or more IP agents 108. In aspects, the one or more modules 116 may also receive the target value 302 from the policy coordinator 112, receive the one or more IP parameters 110 from the one or more IP agents 108, and/or output one or more performance state recommendations 306 to the decision module 114. Types of the one or more modules 116 are further described with respect to FIG. 4. Further details of interactions, which include the one or more modules 116, are described with respect to FIG. 5.

The IP parameters 110 can include, in some examples, subsets of IP parameters 110 from two or more of the one or more IP agents 108. In such examples, the target value 302, the performance state change command 304, the performance state recommendation 306, or any combination of these can be a plurality of target values 302, a plurality of performance state change commands 304, and/or a plurality of performance state recommendations 306, respectively.

For example, one of the one or more IP agents 108 can be the CPU and another of the one or more IP agents 108 can be the video processor. In such an example, a first IP parameter of the one or more IP parameters 110 can be the frequency of the CPU and a second IP parameter of the one or more IP parameters 110 can be the frame rate of the video processor. The policy coordinator 112 can, in this example, provide the plurality of target values 302 based on the frequency of the CPU and configured to change the frequency of the CPU and the frame rate of the video processor and configured to change the frame rate of the video processor. The one or more modules 116 can, in this example, provide the plurality of performance state recommendations 306 including a performance state recommendation 306 based on the frequency of the CPU and configured to change the frequency of the CPU and a performance state recommendation 306 based on the frame rate of the video processor and configured to change the frame rate of the video processor. The decision module 114, in this example, can generate the plurality of performance state change commands 304 including a performance state change command 304 based on the target value 302 and the performance state recommendation 306 that are based on the frequency of the CPU and configured to change the frequency of the CPU. The generated plurality of performance state change commands 304 can, in this example, further include a performance state change command 304 based on the target value 302 and the performance state recommendation 306 that are based on the frame rate of the video processor and configured to change the frame rate of the video processor.

In aspects, the plurality of target values 302 may be target values corresponding to performance, power, and/or temperature. For example, the policy coordinator 112 may output a power target value to the decision module 114. The plurality of target values 302 may be further based on one or more settings. In aspects, the one or more settings can be based on one or more user inputs and a user may decide on user inputs based on one or more of an IP agent workload, a performance setting, a frame rate, a power consumption rate, a latency, a quality measure, or a user experience setting. For example, a user (e.g., the user 104 of FIG. 1) may specify the frame rate and the power consumption rate on their computing device (e.g., the computing device 102 of FIG. 1) to allow for a better gaming experience. An SoC (e.g., the SoC 106 of FIG. 1) within the computing device may update the power, performance, and temperature policies to fulfill the user's specifications and ensure a reliable user experience.

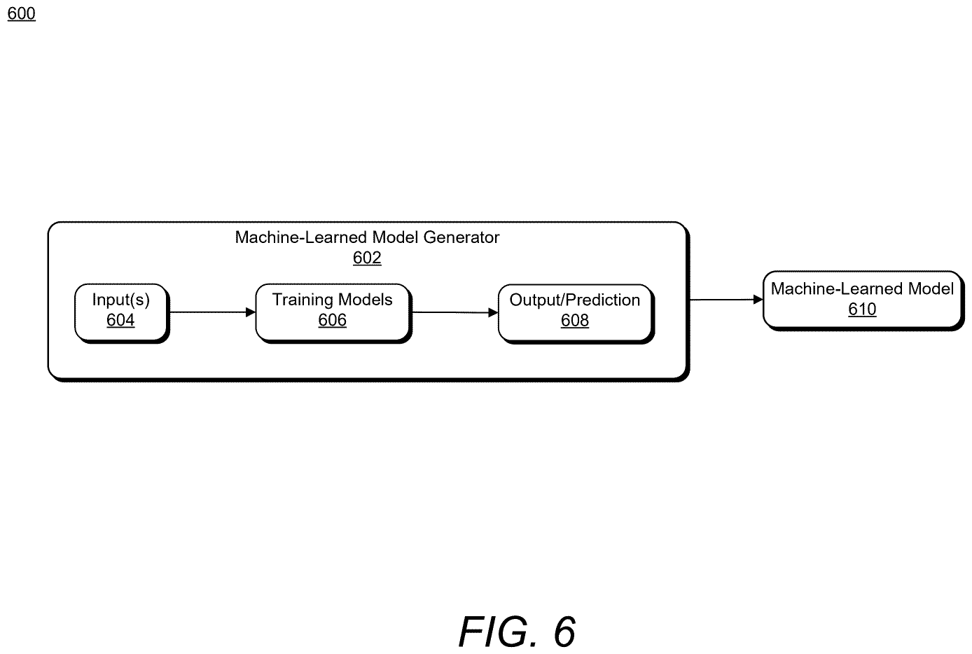

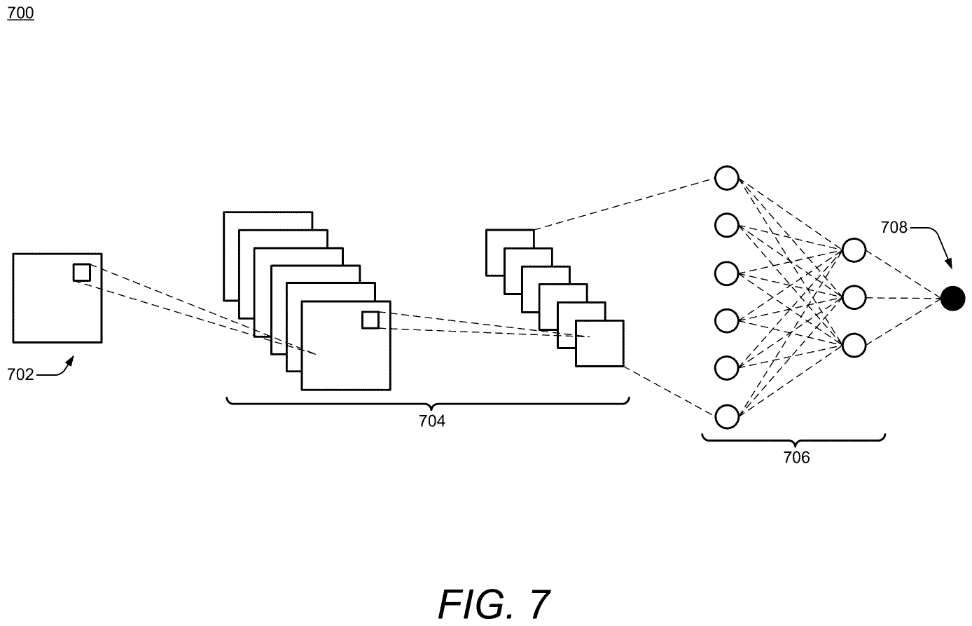

In some examples, the outputs of the policy coordinator 112, the decision module 114, and/or the one or more modules 116 can be based on a machine-learned (ML) model. For example, the decision module 114 can include an ML model that takes the target value 302 and the performance state recommendation 306 as inputs, providing the performance state change command 304 as an ML output. In some examples, other inputs can also be used by the ML model, such as the one or more IP parameters 110, one or more threshold values, one or more policies, etc. Additional aspects relating to ML are described with respect to FIGS. 6 and 7.

FIG. 4 illustrates example modules 116 for efficiency-aware performance bounds in SoC design in an example implementation 400. In aspects, a performance optimizer module 402 may receive performance target values from the policy coordinator 112 of FIG. 1, performance values from the one or more IP agents 108 of FIG. 1, and/or lookup performance values from a lookup table (LUT). For example, the performance optimizer module 402 may generate and output a performance module performance state recommendation based on a comparison between a performance value from the one or more IP agents 108 and the performance target value. The performance optimizer module 402 may further generate a lower bound performance value including a minimum performance parameter for the one or more IP agents 108. In another example, the performance optimizer module 402 may generate and output a performance module performance state recommendation based on a comparison between a lookup performance value from the LUT and the performance target value.

The performance optimizer module 402 can, in aspects, monitor current performance values and compare them against a performance target value (e.g., the target value 302 of FIG. 3) from a policy coordinator (e.g., the policy coordinator 112 of FIG. 1). The performance optimizer 402 can ensure that the current performance values are greater than or equal to the performance target value. For example, in a CPU, performance may be determined by a number of instructions executed per cycle. The performance optimizer module 402 may continuously monitor this metric and check if it meets the performance target value. If the CPU is executing fewer instructions per cycle than required, the performance optimizer module 402 may adjust the operating settings to ensure that performance stays at or above the performance target value. In another example, the performance optimizer module 402 may use the LUT representing performance as a function of performance state. The LUT may be used to calculate the minimum required performance value (e.g., the lower bound performance value) to satisfy the performance target value.

In some examples, the performance optimizer module 402 may be a machine-learned model. In other examples, the performance optimizer module 402 may output at least one of the performance value, the performance target value, the lookup performance value, or the performance module performance state recommendation in a time-series format.

In aspects, a power optimizer module 404 may receive power target values from the policy coordinator 112 of FIG. 1, power values from the one or more IP agents 108 of FIG. 1, and/or activity factors from the LUT. For example, the power optimizer module 404 may generate and output a power module performance state recommendation based on a comparison between a power value from the one or more IP agents and the power target value. The power optimizer module 404 may further generate a lower bound power value including a minimum power parameter for the one or more IP agents and/or an upper bound power value including a maximum power parameter for the one or more IP agents. In another example, the power optimizer module 404 may generate and output a power module performance state recommendation based on a comparison between an activity factor from the LUT and the power target value. The power optimizer module 404 may further calculate a power leakage value based on the activity factor and may generate the power module performance state recommendation based on the power leakage value.

The power optimizer module 404 can continuously compare real-time power data with power target values to ensure optimal system performance for a user. For example, a user may stream videos on their computing device (e.g., a smartphone) while the power optimizer module 404 continuously checks the actual power consumption of the CPU and GPU (e.g., IP agents) against a power target value. If the power values from the CPU and GPU are too low, the power optimizer module 404 can enforce the lower bound power value to prevent video stuttering. If the power values from the IP agents exceed the power target value, the power optimizer module 404 can apply the upper bound power value to avoid unnecessary energy waste and overheating.

In some examples, the power optimizer module 404 may be a machine-learned model. In other examples, the power optimizer module 404 may output at least one of the power value, the power target value, or the power module performance state recommendation in a time-series format.

In aspects, a thermal controller module 406 may receive temperature target values from the policy coordinator 112 of FIG. 1, temperature values from the one or more IP agents 108 of FIG. 1, or both. For example, the thermal controller module 406 may generate and output a thermal module performance state recommendation based on a comparison between a temperature value from one or more IP agents 108 and a temperature target value. The thermal controller module 406 may further generate an upper bound temperature value including a maximum temperature parameter for the one or more IP agents. In an example, a user may be running a gaming application on their computing device (e.g., a smartphone). The thermal controller module 406 can continuously monitor the CPU and GPU temperatures and compare them against the temperature target value. If the temperature exceeds the temperature target value, the thermal controller module 406 can impose the upper bound temperature value to prevent the computing device from overheating. In some examples, the thermal controller module 406 may be a machine-learned model. In other examples, the thermal controller module 406 may output at least one of the temperature value, the temperature target value, or the thermal module performance state recommendation in a time-series format.

In aspects, an efficiency optimizer module 408 may receive a performance module performance state recommendation from the performance optimizer module 402 and a power module performance state recommendation from the power optimizer module 404. Based on a comparison between the performance module performance state recommendation and the power module performance state recommendation, the efficiency optimizer module 408 can generate an efficiency module performance state recommendation. In further aspects, the efficiency optimizer module 408 may receive one or more settings based on the one or more IP parameters 110 of FIG. 1 and can generate an upper bound performance value including a maximum performance parameter for the one or more IP agents 108 of FIG. 1. In some aspects, the upper bound performance value may be based on the one or more settings. In some examples, the efficiency optimizer module 408 may be a machine-learned model.

In aspects, a trend monitor module 410 may receive at least one of the one or more IP parameters 110 in a time series format. Based on the IP parameters 110, the trend monitor module 410 can generate prediction IP parameters. The prediction IP parameters can include predictions of the IP parameters 110 in a future state. In some examples, the trend monitor module 410 can analyze temperature values and power values through a lowpass filter while comparing the temperature target value and the power target value. In some examples, the trend monitor module 410 may be a machine-learned model.

FIG. 5 illustrates an example implementation 500 of efficiency-aware performance bounds in SoC design. In aspects, the decision module 114 of FIG. 1 receives the target value 302 of FIG. 3 from the policy coordinator 112 of FIG. 1 and one or more module performance state recommendations (e.g., the performance state recommendation 306 of FIG. 3) from the one or more modules 116 of FIG. 1. Based on the target value 302 and/or the one or more module performance state recommendations, the decision module 114 provides the performance state change command 304 of FIG. 3 to the one or more IP agents 108 of FIG. 1.

In aspects, the one or more IP agents 108 output the one or more IP parameters 110 of FIG. 1 to one or more of the policy coordinator 112, the performance optimizer module 402 of FIG. 4, the power optimizer module 404 of FIG. 4, the thermal controller module 406 of FIG. 4, and the trend monitor module 410 of FIG. 4. In some examples, any one or more of the performance optimizer module 402, the power optimizer module 404, the thermal controller module 406, and the efficiency optimizer module 408 can output a module performance state recommendation to the decision module 114. The decision module 114, in aspects, generates the performance state change command 304. In some examples, the performance state change command 304 can be a selection of the one or more module performance state recommendations. In some examples, the selection is based on a minimum of or a combination of the target value 302 and/or the one or more module performance state recommendations (e.g., a comparison, a weighted sum, etc.).

In some examples, the policy coordinator 112 receives or includes one or more settings 502. The one or more settings 502 can, in some examples, be based on the one or more IP agents 108 and can include user inputs based on one or more of an IP agent workload, a performance setting, a frame rate, a power consumption rate, a latency, a quality measure, or a user experience setting. In some examples, the one or more settings 502 can be configured to provide an initial or default performance state or an initial or default policy coordinator condition. In some aspects, the one or more settings 502 are based on the one or more IP parameters 110. In other aspects, the one or more settings 502 are not based on the one or more IP parameters 110.

In some examples, the performance optimizer module 402 can receive a lookup performance value from an LUT 504. A performance module performance state recommendation (e.g., a module performance state recommendation) may be based on the lookup performance value from the LUT 504. In some examples, the power optimizer module 404 can receive an activity factor 506. A power module performance state recommendation may be based on the activity factor 506. In some examples, the power optimizer module 404 can calculate a power leakage value based on the activity factor 506.

The various pathways of FIG. 5 show the possible logical connections between the policy coordinator 112, the decision module 114, the one or more modules 116, and the IP agents 108. For example, the policy coordinator 112 can output target values 302 to the performance optimizer module 402, the power optimizer module 404, the thermal controller module 406, and the decision module 114. In some examples, the target values 302 can be one or more of a performance target value, a power target value, and a temperature target value. In some examples, the performance optimizer module 402 and the power optimizer module 404 can output module performance state recommendations to the efficiency optimizer module 408. The efficiency optimizer module 408 can, in some examples, select which module performance state recommendation to output to the decision module 114 based on user inputs (e.g., settings 502) and/or a weighted minimum operation. The efficiency optimizer module 408 may output an efficiency module performance state recommendation to the decision module 114.

In some examples, the thermal controller module 406 may output a thermal module performance state recommendation to the decision module 114. In some examples, the trend monitor module 410 can receive the one or more IP parameters 110 in a time-series format and can generate one or more prediction IP parameters based on the one or more IP parameters 110. The trend monitor module 410 can output the one or more prediction IP parameters to the decision module 114. In such an example, the decision module 114 can base the performance state change command 304 on the one or more prediction IP parameters. Multiple output possibilities indicated in FIG. 5 from a single module of the one or more modules 116 can be, in some examples, output along any one or more of the possible output paths. In some examples, fewer than all of the one or more modules 116 provide an output to the decision module 114. In some examples, at least one of the one or more modules 116 can provide multiple outputs to the decision module 114. Various alternate and/or combination pathways not pictured for clarity can, in some examples, be equally employed.

### Machine Learning

An ML model, as discussed in this disclosure, refers to a computer model that has been trained using one or more machine-learning techniques. In general, this training may be done by providing training inputs to one or more training models, which in turn may provide an output. The output may be in the form of a prediction, a confidence score, or another probability-based output.

FIG. 6 illustrates an example of machine-learning 600, as outlined in this disclosure. An ML model generator 602 may include training elements in the form of inputs 604, training models 606, and outputs 608 and may be used to generate an ML model 610 (e.g., the decision module 114, the performance optimizer module 402, the power optimizer module 404, the thermal controller module 406, the efficiency optimizer module 408). The inputs 604 may be training data. The training data 604 may be processed by the training models 606. Examples of the training models 606 include multi-layer perceptron (MLP) models, convolutional neural networks (CNN), long short-term memory (LSTM) algorithms, generative adversarial networks (GAN), K means clustering, Gaussian mixture models (GMM), or any other of a number of machine learning training techniques known to a person of ordinary skill in the art. The training models 606 may include a single type of model or multiple types, as well as various combinations of types including combinations of single types and of multiple types.

The training models 606 may use supervised learning methods, where the training data 604 may be labeled and the outputs 608 may be graded based on their fidelity to a “truth” output. The training models 606 may use an unsupervised learning method, where there may not be labels on the training data 604 and the training models 606 may classify correlations without reference to a “truth” value. The training models 606 may combine supervised and unsupervised techniques.

The input 604 may be related to IP agent outputs (e.g., the one or more IP parameters 110 of FIG. 1). For example, the input 604 may be temperature measurements for one or more processors or one or more processor cores (e.g., the one or more processors of the one or more IP agents 108 of FIG. 1), processor or core workload, performance characteristics, idle times, scheduling, or other or a combination of these input types. The input 604 may also be from training data used to generate the ML model 610. The training data may comprise data of any of the input types described above, created for the purpose of training the ML model 610. The ML model 610 may be generated once the training of the ML model generator 602 is complete. The ML model 610 may be trained on a same device on which the ML model 610 is stored (e.g., the computing device 102 of FIG. 1) or at least one other device.

The ML model 610 may be updated with additional training after it has been initially trained. In aspects, the ML model 610 may have the same structure before and after training but may have one or more different values, such as starting vs. final values for weights and biases. In some examples, the ML model 610 may start with a different architecture prior to training, and in this way the generated ML model 610 may have architecture that is a product of the training done in the ML model generator 602.

FIG. 7 illustrates an example machine-learned architecture 700 for efficiency-aware performance bounds in SoC design. FIG. 7 is not meant to be limiting but to show one possible example out of many, which a person skilled in the art may be able to employ. The ML architecture 700 may have inputs 702. The inputs 702 may be related to IP agent outputs (e.g., the one or more IP parameters 110 of FIG. 1), module outputs (e.g., the one or more module performance state recommendations of the one or more modules 116), LUT outputs (e.g., the one or more lookup performance values from the LUT 504), etc. For example, the inputs 702 may be temperature measurements for one or more processors or one or more processor cores, processor or core workload, performance characteristics, idle times, scheduling, or other or a combination of these input types. In this example, the inputs 702 are first processed by a CNN 704. The CNN 704 may extract features from the inputs 702. For example, extracted features may contain elements such as motion detection, object recognition, person recognition, other elements and features common to video and image processing and identification, processor parameter-related correlations, IP parameter-related correlations, performance state-related correlations, or other correlations.

The CNN 704 may be a disconnected neural network, meaning all members of the neural network, such as perceptrons, may not be in a causal relationship with one another. It should be mentioned that other feature extraction techniques besides CNNs may be equally employed in lieu of the CNN 704. An MLP 706 neural network may receive the extracted feature outputs from the CNN 704 as inputs. The MLP 706 may be a fully connected network, which may comprise all perceptrons in a causal relationship with one another. The MLP 706 may have as an output a detection probability in the form of a prediction 708. The prediction 708 may be, for example, the selection from the efficiency optimizer module 408 as discussed in relation to FIG. 4 or the prediction of the one or more IP parameters in the future state from the trend monitor module 410.

An ML model trained by a trainer such as the ML architecture 700 may exhibit similar architecture. For example, suppose the ML architecture 700 uses a matrix containing the one or more IP parameters 110, the one or more target values 302, and the one or more module performance state recommendations as the inputs 702 and provides a prediction of further processor parameters (e.g., the selection from the efficiency optimizer module 408, the prediction from the trend monitor module 410) represented as numbers between 0 and 1 as the prediction 708. The ML model trained by the ML architecture 700 may take a matrix of input data as described in the example above as its input and output a probability vector with elements between 0 and 1 indicating the probability of the future processor parameters. The ML model may have one or more feature extraction layers, such as the CNN 704, and one or more fully connected layers, such as the MLP 706.

In aspects, feature extraction, such as that done by the feature extraction layers of the CNN 704, may be accomplished by correlating areas of the inputs 702. Such correlations may, for example, be established using a disconnected network, the disconnected network not having all neurons causally connected by necessity. The feature extraction layers may, in aspects, utilize windows of analysis within the inputs 702, the windows of analysis in some examples overlapping one another. The feature extraction layers may, in aspects, be a product of unsupervised learning. In some examples, the feature extraction is an intermediate ML output.

Though FIG. 7 depicts the ML architecture 700 as incorporating both feature extraction, such as from the CNN 704 portion, and selection and/or interpolation, such as from the MLP 706 portion, these ML models may be distinct. For example, there may be a trained generation model corresponding to the CNN 704, a trained selection model corresponding to at least a portion of the MLP 706, and a trained interpolation model corresponding to at least a portion of the MLP 706. Some or all of these ML models may be combined, or other ML models, including types not shown in FIG. 7.

It will be understood by a person of ordinary skill in the art that the aforementioned are merely examples of the types of machine-learning training that may be used to produce an ML model for any aspect of efficiency-aware performance bounds in SoC design. Other combinations and techniques may be employed, which do not alter the scope of the inventive concept of an ML-based prediction and dynamic core allocation architecture. Examples such as employing a CNN, use of the one or more IP parameters 110 as inputs, including a fully connected portion of the machine learning training, etc. are not meant to be limiting but to serve as examples of how an ML model for generating predictions of future IP parameters may be accomplished.

### Example Methods

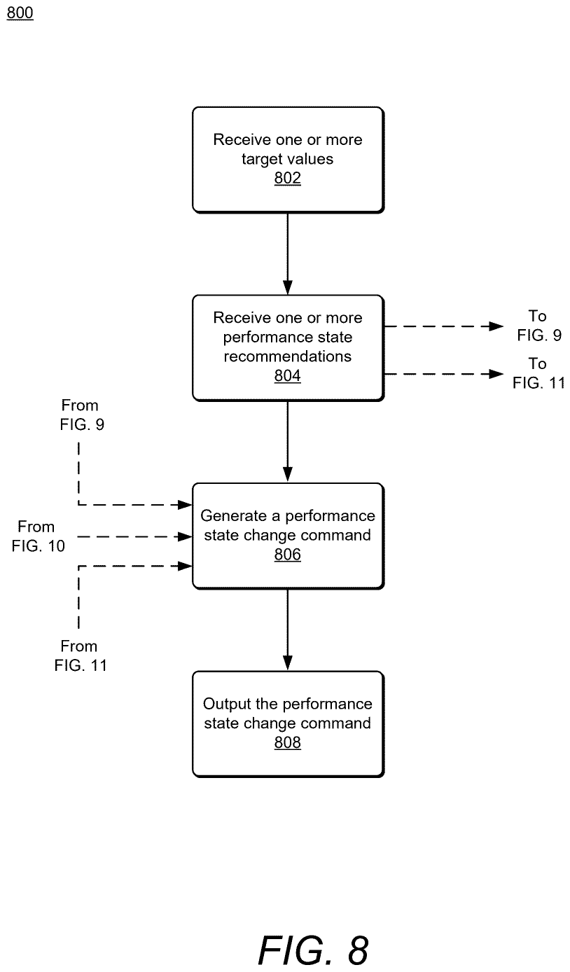

FIGS. 8, 9, 10, and 11 depict example methods 800, 900, 1000, and 1100 for implementing aspects of efficiency-aware performance bounds in SoC design. The methods 800, 900, 1000, and 1100 are shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1 and entities detailed in FIGS. 1-7, reference to which is made for example only. The techniques are not limited to performance by one entity or multiple entities operating on one device.

FIG. 8 illustrates the example method 800 for performing efficiency-aware performance bounds in SoC design. At 802 one or more target values (e.g., target value 302) are received by a decision module (e.g., the decision module 114 of FIG. 1) and from a policy coordinator (e.g., the policy coordinator 112 of FIG. 1). In some examples, the one or more target values are based on one or more IP parameters (e.g., the one or more IP parameters 110 of FIG. 1) of one or more IP agents (e.g., one or more IP agents 108 of FIG. 1). In further examples, the one or more IP parameters are based on one or more IP performance states of the one or more IP agents. The IP parameters, in some examples, can include at least one or a performance value of at least one of the one or more IP agents, a power value of the at least one of the one or more IP agents, or a temperature value of the at least one of the one or more IP agents.

At 804, one or more performance state recommendations (e.g., the performance state recommendation 306 of FIG. 3) are received by the decision module and from one or more processing modules (e.g., the one or more modules 116 of FIG. 1). In some examples, the one or more performance state recommendations are configured to alter the one or more IP performance states.

At 806, a performance state change command (e.g., the performance state change command 304 of FIG. 3) is generated based on the one or more target values and the one or more performance state recommendations. In some examples, the performance state change command is configured to change the one or more IP performance states of the one or more IP agents. At 808, the performance state change command is outputted to the one or more IP agents.

In some examples, the one or more IP agents includes a plurality of IP agents and the one or more IP performance states includes a plurality of IP performance states. Each of the plurality of IP performance states, in some examples, can correspond to a different one of the plurality of IP agents. The performance state change command, in some examples, includes a plurality of performance state change commands. According to some examples, each of the plurality of performance state change commands corresponds to a different one of the plurality of IP agents. The outputting of the performance state change command, in some examples, includes outputting each of the plurality of performance state change commands to the respective one of the plurality of IP agents.

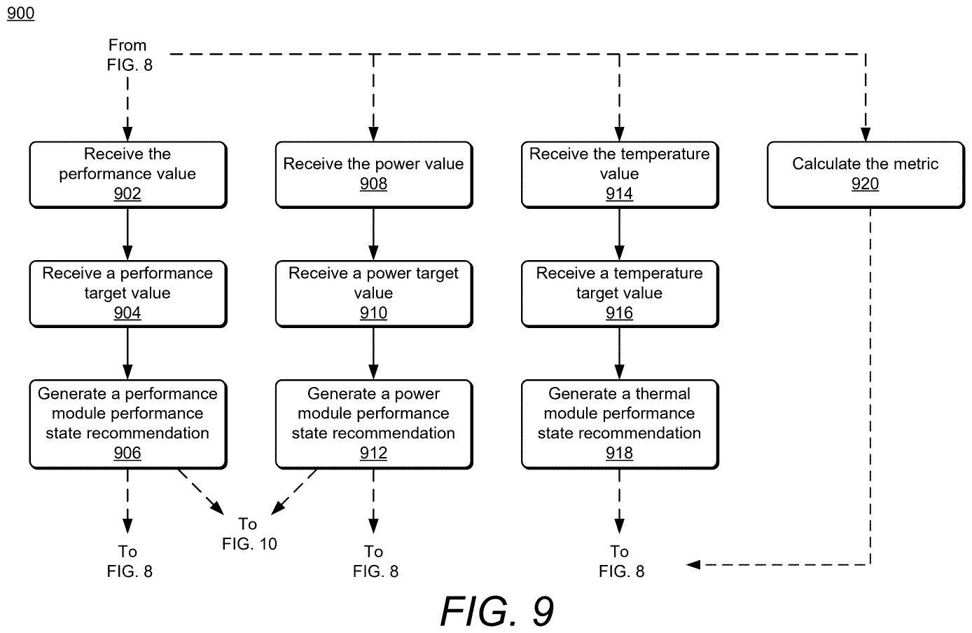

FIG. 9 illustrates the example method 900 for performing efficiency-aware performance bounds in SoC design. The method 900 includes the method 800. At 902, the performance value of at the least one of the one or more IP agents is received by a performance optimizer module (e.g., the performance optimizer module 402 of FIG. 4). At 904, a performance target value (e.g., target value 302 of FIG. 3) of the one or more target values is received by the performance optimizer module. In some examples, the performance target value is based on the performance value of the at least one of the one or more IP agents.

At 906, a performance module performance state recommendation is generated by the performance optimizer module. In some examples, the performance module performance state recommendation is based on the performance value and the performance target value. The performance optimizer module, in some examples, compares the performance value of the at least one of the one or more IP agents and the performance target value of the one or more target values. In aspects, the performance module performance state recommendation may be based on the comparison.

In some examples, a lower bound performance value including a minimum performance parameter for the at least one of the one or more IP agents is generated by the performance optimizer module. In aspects, the lower bound performance value is based on the performance target value and the comparison of the performance value and the performance target value is further based on the lower bound performance value. In further examples, the one or more performance state recommendations includes the performance module performance state recommendation. The performance optimizer module, in some examples, can output the performance module performance state recommendation to the decision module. In other examples, the performance optimizer module can output the performance module performance state recommendation to an efficiency optimizer module (e.g., the efficiency optimizer module 408 of FIG. 4). In aspects, at least one of the performance value, the performance target value, or the performance module performance state recommendation is in a time-series format.

At 908, the power value of at the least one of the one or more IP agents is received by a power optimizer module (e.g., the power optimizer module 404 of FIG. 4). At 910, a power target value of the one or more target values is received by the power optimizer module. In some examples, the power target value is based on the power value of the at least one of the one or more IP agents.

At 912, a power module performance state recommendation is generated by the power optimizer module. In some examples, the power module performance state recommendation is based on the power value and the power target value. The power optimizer module, in some examples, compares the power value of the at least one of the one or more IP agents and the power target value of the one or more target values. In aspects, the power module performance state recommendation may be based on the comparison.

In some examples, at least one or a lower bound power value or a an upper bound power value are generated by the power optimizer module. In aspects, the lower bound power value includes a minimum power parameter for the at least one of the one or more IP agents and the upper bound power value includes a maximum power parameter for the at least one of the one or more IP agents. In some examples, the lower bound power value is based on the power target value, the upper bound power value is based on the power target value, and the comparison of the power value and the power target value is based on at least one of the lower bound power value or the upper bound power value. In further examples, the one or more performance state recommendations includes the power module performance state recommendation. The power optimizer module, in some examples, can output the power module performance state recommendation to the decision module. In other examples, the power optimizer module can output the power module performance state recommendation to the efficiency optimizer module. In aspects, at least one of the power value, the power target value, or the power module performance state recommendation is in a time-series format.

At 914, the temperature value of at the least one of the one or more IP agents is received by a thermal controller module (e.g., the thermal controller module 406 of FIG. 4). At 916, a temperature target value of the one or more target values is received by the thermal controller module. In some examples, the temperature target value is based on the temperature value of the at least one of the one or more IP agents.

At 918, a thermal module performance state recommendation is generated by the thermal controller module. In some examples, the thermal module performance state recommendation is based on the temperature value and the temperature target value. The thermal controller module, in some examples, compares the temperature value of the at least one of the one or more IP agents and the temperature target value of the one or more target values. In aspects, the thermal module performance state recommendation may be based on the comparison.

In some examples, an upper bound temperature value is generated by the thermal controller module. In aspects, the upper bound temperature value includes a maximum temperature parameter for the at least one of the one or more IP agents. In some examples, the upper bound temperature value is based on the temperature target value and the comparison of the temperature value and the temperature target value is based on the upper bound temperature value. In further examples, the one or more performance state recommendations includes the thermal module performance state recommendation. The thermal controller module, in some examples, can output the thermal module performance state recommendation to the decision module. In aspects, at least one of the temperature value, the temperature target value, or the thermal module performance state recommendation is in a time-series format.

At 920, a metric is calculated by the decision module. In some examples, the metric is based on the one or more target values, the one or more performance state recommendations, and/or one or more IP parameters (e.g., the one or more IP parameters 110 of FIG. 1). The calculation of the metric, in some examples, includes a weighted sum of the one or more target values and the one or more performance state recommendations. In some examples, the performance state change command is based on the metric. In some examples, the metric is a combination of one or more of the one or more target values, the one or more performance state recommendations, and/or one or more IP parameters. For example, the metric can be a weighted average of the one or more target values, including one or more historical target values.

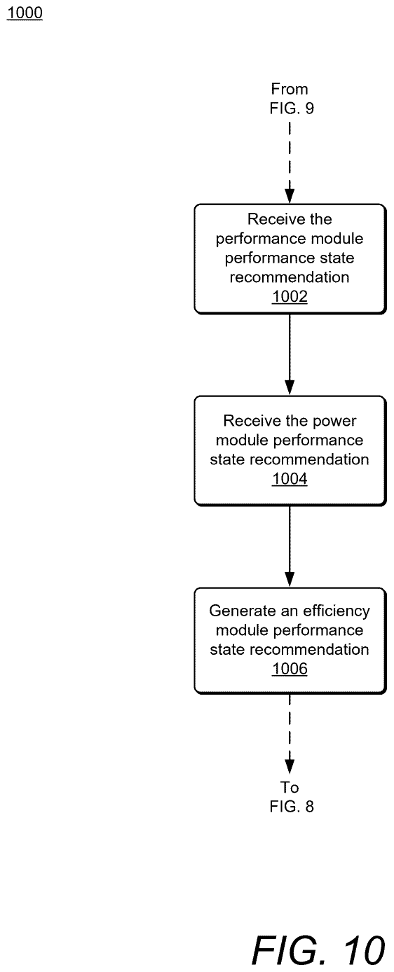

FIG. 10 illustrates the example method 1000 for performing efficiency-aware performance bounds in SoC design. The method 1000 includes the methods 800 and 900. At 1002, the performance module performance state recommendation is received by the efficiency optimizer module. At 1004, the power module performance state recommendation is received by the efficiency optimizer module.

At 1006, an efficiency module performance state recommendation is generated by the efficiency optimizer module. In some examples, the efficiency module performance state recommendation is based on the power module performance state recommendation and the performance module performance state recommendation. In further examples, the one or more performance state recommendations include the efficiency module performance state recommendation. The efficiency optimizer module, in some examples, compares the power module performance state recommendation and the performance module performance state recommendation. In aspects, the efficiency module performance state recommendation may be based on the comparison. In some examples, one or more settings based on the one or more IP parameters are received by the efficiency optimizer module. An upper bound performance value, in some examples, is generated by the efficiency optimizer module. In aspects, the upper bound performance value includes a maximum performance parameter for the at least one of the one or more IP agents. In some examples, the upper bound performance value is based on the one or more settings and the comparison of the power module performance state recommendation and the performance module performance state recommendation is based on the upper bound performance value.

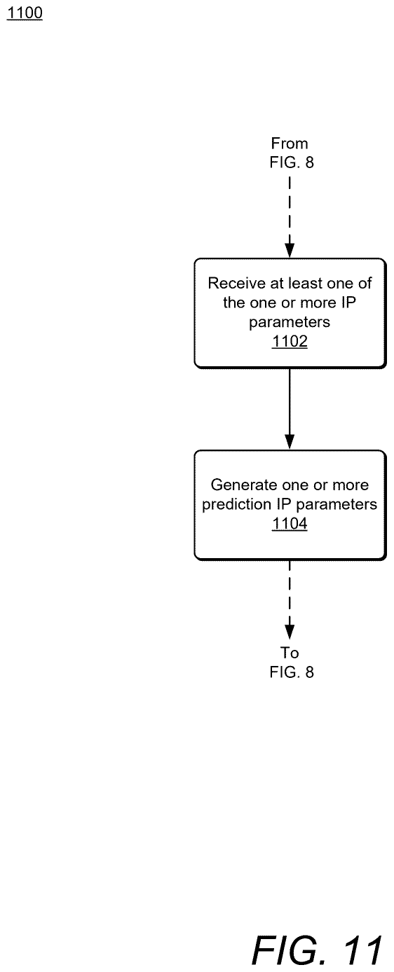

FIG. 11 illustrates the example method 1100 for performing efficiency-aware performance bounds in SoC design. The method 1100 includes the method 800. At 1102, at least one of the one or more IP parameters is received by a trend monitor module (e.g., the trend monitor module 410 of FIG. 4) in a time-series format. At 1104, one or more prediction IP parameters are generated by the trend monitor module. In some examples, the one or more prediction IP parameters is based on the at least on the one or more IP parameters. In aspects, the one or more prediction IP parameters includes on or more predictions of the one or more IP parameters in a future state. In further examples, the performance state change command is based on the one or more prediction IP parameters.

### ADDITIONAL EXAMPLES

Some additional examples are described below.

Example 1: A method performed by a system-on-chip (SoC), the method including receiving, by a decision module and from a policy coordinator, one or more target values. The one or more target values are based on one or more intellectual property (IP) parameters of one or more IP agents. The one or more IP parameters are based on one or more IP performance states of the one or more IP agents, the method further includes receiving, by the decision module and from one or more processing modules, one or more performance state recommendations, the one or more performance state recommendations configured to alter the one or more IP performance states. The method further includes generating, based on the one or more target values and the one or more performance state recommendations, a performance state change command, the performance state change command configured to change the one or more IP performance states of the one or more IP agents, and outputting the performance state change command to the one or more IP agents.

Example 2: The method of example 1, where the one or more target values are further based on one or more settings and the one or more settings are based on the one or more IP agents.

Example 3: The method of example 2, where the one or more settings are based on one or more user inputs.

Example 4: The method of example 3, where the one or more user inputs are based on one or more of an IP agent workload, a performance setting, a frame rate, a power consumption rate, a latency, a quality measure, or a user experience setting.

Example 5: The method of example 1, where the one or more IP agents include one or more of a central processing unit (CPU), a graphics processing unit (GPU), a digital signal processor (DSP), a memory controller, a universal serial bus (USB) controller, a peripheral component interconnect express (PCIe) controller, an Ethernet controller, an Inter-Integrated Circuit (I2C) controller, a Serial Peripheral Interface (SPI) controller, a Direct Memory Access (DMA) controller, a WiFi™ controller, a Bluetooth™ controller, a hardware security module (HSM), a random number generator (RNG), an analog-to-digital converter (ADC), a digital-to-analog converter (DAC), a sensor, an audio processor, a video processor, a cryptographic accelerator, or an image sensor interface.

Example 6: The method of example 1, where the one or more processing modules include at least one of a performance optimizer module, a power optimizer module, a thermal controller module, an efficiency optimizer module, or a trend monitor module.

Example 7: The method of example 6, where the one or more IP parameters include at least one of a performance value of at least one of the one or more IP agents, a power value of the at least one of the one or more IP agents, or a temperature value of the at least one of the one or more IP agents.

Example 8: The method of example 7, where the one or more modules includes the performance optimizer module. The method further includes receiving, by the performance optimizer module, the performance value of the at least one of the one or more IP agents and receiving, by the performance optimizer module, a performance target value of the one or more target values. The performance target value is based on the performance value of the at least one of the one or more IP agents, the method further includes generating, by the performance optimizer module, a performance module performance state recommendation based on the performance value and the performance target value. The one or more performance state recommendations include the performance module performance state recommendation.

Example 9: The method of example 8, further including comparing, by the performance optimizer module, the performance value of the at least one of the one or more IP agents and the performance target value of the one or more target values. The performance module performance state recommendation is further based on the comparison.

Example 10: The method of example 9, further including generating, by the performance optimizer module, a lower bound performance value including a minimum performance parameter for the at least one of the one or more IP agents. The lower bound performance value is based on the performance target value and the comparison of the performance value, and the performance target value is further based on the lower bound performance value.

Example 11: The method of example 8, where the performance optimizer module includes a machine-learned (ML) model.

Example 12: The method of example 8, further including receiving, by the performance optimizer module, a lookup performance value from a lookup table (LUT), where the performance module performance state recommendation is further based on the lookup performance value.

Example 13: The method of example 8, where at least one of the performance value, the performance target value, or the performance module performance state recommendation is in a time-series format.

Example 14: The method of example 7, where the one or more modules includes the power optimizer module. The method further includes receiving, by the power optimizer module, the power value of the at least one of the one or more IP agents and receiving, by the power optimizer module, a power target value of the one or more target values. The power target value is based on the power value of the at least one of the one or more IP agents. The method further includes generating, by the power optimizer module, a power module performance state recommendation based on the power value and the power target value. The one or more performance state recommendations include the power module performance state recommendation.

Example 15: The method of example 14, further including comparing, by the power optimizer module, the power value of the at least one of the one or more IP agents and the power target value of the one or more target values, where the power module performance state recommendation is further based on the comparison.

Example 16: The method of example 15, further including generating, by the power optimizer module, at least one of a lower bound power value including a minimum power parameter for the at least one of the one or more IP agents or an upper bound power value including a maximum power parameter for the at least one of the one or more IP agents. The lower bound power value is based on the power target value. The upper bound power value is based on the power target value. The comparison of the power value and the power target value is based on at least one of the lower bound power value or the upper bound power value.

Example 17: The method of example 14, where the power optimizer module includes an ML model.

Example 18: The method of example 14, further including receiving, by the power optimizer module, an activity factor from an LUT. The power module performance state recommendation is further based on the activity factor.

Example 19: The method of example 18, further including calculating, by the power optimizer module, a power leakage value based on the activity factor. The generation of the power module performance state recommendation is further based on the power leakage value.

Example 20: The method of example 14, where at least one of the power value, the power target value, or the power module performance state recommendation is in a time-series format.

Example 21: The method of example 7, where the one or more modules includes the thermal controller module. The method further includes receiving, by the thermal controller module, the temperature value of the at least one of the one or more IP agents and receiving, by the thermal controller module, a temperature target value of the one or more target values. The temperature target value is based on the temperature value of the at least one of the one or more IP agents. The method further includes generating, by the thermal controller module, a thermal module performance state recommendation based on the temperature value and the temperature target value. The one or more performance state recommendations include the thermal module performance state recommendation.

Example 22: The method of example 21, further including comparing, by the thermal controller module, the temperature value of the at least one of the one or more IP agents and the temperature target value of the one or more target values. The thermal module performance state recommendation is further based on the comparison.

Example 23: The method of example 22, further including generating, by the thermal controller module, an upper bound temperature value including a maximum temperature parameter for the at least one of the one or more IP agents. The upper bound temperature value is based on the temperature target value and the comparison of the temperature value, and the temperature target value is based on the upper bound temperature value.

Example 24: The method of example 21, where the thermal controller module includes an ML model.

Example 25: The method of example 21, where at least one of the temperature value, the temperature target value, or the thermal module performance state recommendation is in a time-series format.

Example 26: The method of example 8, where the one or more modules further include the power optimizer module and the efficiency optimizer module. The method further includes receiving, by the power optimizer module, the power value of the at least one of the one or more IP agents and receiving, by the power optimizer module, a power target value of the one or more target values. The power target value is based on the power value of the at least one of the one or more IP agents. The method further includes generating, by the power optimizer module, a power module performance state recommendation based on the power value and the power target value. The one or more performance state recommendations include the power module performance state recommendation, the method further includes receiving, by the efficiency optimizer module, the power module performance state recommendation and receiving, by the efficiency optimizer module, the performance module performance state recommendation. The method further includes generating, by the efficiency optimizer module, an efficiency module performance state recommendation based on the power module performance state recommendation and the performance module performance state recommendation. The one or more performance state recommendations include the efficiency module performance state recommendation. The including of the performance module performance state recommendation in the one or more performance state recommendations includes the including of the efficiency module performance state recommendation in the one or more performance state recommendations.

Example 27: The method of example 26, further including comparing, by the efficiency optimizer module, the power module performance state recommendation and the performance module performance state recommendation. The efficiency module performance state recommendation is further based on the comparison.

Example 28: The method of example 27, further including receiving, by the efficiency optimizer module, one or more settings based on the one or more IP parameters. The method further includes generating, by the efficiency optimizer module, an upper bound performance value including a maximum performance parameter for the at least one of the one or more IP agents. The upper bound performance value is based on the one or more settings and the comparison of the power module performance state recommendation and the performance module performance state recommendation is based on the upper bound performance value.

Example 29: The method of example 26, where the efficiency optimizer module includes an ML model.

Example 30: The method of example 6, where the one or more modules include the trend monitor module. The method further includes receiving, by the trend monitor module, at least one of the one or more IP parameters in a time-series format and generating, by the trend monitor module and based on the at least one of the one or more IP parameters, one or more prediction IP parameters including one or more predictions of the one or more IP parameters in a future state. The performance state change command is further based on the one or more prediction IP parameters.

Example 31: The method of example 30, where the trend monitor module includes an ML model.

Example 32: The method of example 1, where the decision module includes a metric. The method further includes calculating, by the decision module, the metric based on the one or more target values and the one or more performance state recommendations. The performance state change command is based on the metric.

Example 33: The method of example 32, where the calculation of the metric includes a weighted sum of the one or more target values and the one or more performance state recommendations.

Example 34: The method of example 1, where the decision module includes an ML model.

Example 35: A system-on-chip including one or more processors, one or more process modules, and a memory storing instructions that, when accessed by the one or more processors, cause the one or more processors to perform the method of any one of examples 1-34.

Example 36: A non-transitory, computer-readable medium storing instructions that, when accessed by one or more processors, causes the one or more processors to perform the method of any one of examples 1-34.

Example 37: A computer programming product storing instructions that, when accessed by one or more processors, causes the one or more processors to perform the method of any one of examples 1-34.

### CONCLUSION

Although techniques using, and apparatuses including, efficiency-aware performance bounds in SoC design have been described in language specific to features and/or methods, it is to be understood that the subject of the appended claims is not necessarily limited to the specific features or methods described. Rather, the specific features and methods are disclosed as example implementations of efficiency-aware performance bounds in SoC design.

What is claimed is:

1. A method performed by a system-on-chip (SoC), the method comprising:
receiving, by a decision module and from a policy coordinator, one or more target values, the one or more target values based on one or more intellectual property (IP) parameters of one or more IP agents, the one or more IP parameters based on one or more IP performance states of the one or more IP agents;
receiving, by the decision module and from one or more processing modules, one or more performance state recommendations, the one or more performance state recommendations configured to alter the one or more IP performance states;
generating, based on the one or more target values and the one or more performance state recommendations, a performance state change command, the performance state change command configured to change the one or more IP performance states of the one or more IP agents; and
outputting the performance state change command to the one or more IP agents.

2. The method of claim 1, wherein the one or more processing modules comprise at least one of:
a performance optimizer module;
a power optimizer module;
a thermal controller module;
an efficiency optimizer module; or
a trend monitor module.

3. The method of claim 2, wherein the one or more IP parameters comprise at least one of a performance value of at least one of the one or more IP agents, a power value of the at least one of the one or more IP agents, or a temperature value of the at least one of the one or more IP agents.

4. The method of claim 3, wherein the one or more modules comprises the performance optimizer module, the method further comprising:
receiving, by the performance optimizer module, the performance value of the at least one of the one or more IP agents;
receiving, by the performance optimizer module, a performance target value of the one or more target values, the performance target value based on the performance value of the at least one of the one or more IP agents; and
generating, by the performance optimizer module, a performance module performance state recommendation based on the performance value and the performance target value, wherein the one or more performance state recommendations include the performance module performance state recommendation.

5. The method of claim 4, further comprising comparing, by the performance optimizer module:
the performance value of the at least one of the one or more IP agents; and
the performance target value of the one or more target values, wherein the performance module performance state recommendation is further based on the comparison.

6. The method of claim 5, further comprising generating, by the performance optimizer module, a lower bound performance value comprising a minimum performance parameter for the at least one of the one or more IP agents, wherein:
the lower bound performance value is based on the performance target value; and
the comparison of the performance value and the performance target value is further based on the lower bound performance value.

7. The method of claim 3, wherein the one or more modules comprises the power optimizer module, the method further comprising:
receiving, by the power optimizer module, the power value of the at least one of the one or more IP agents;
receiving, by the power optimizer module, a power target value of the one or more target values, the power target value based on the power value of the at least one of the one or more IP agents; and
generating, by the power optimizer module, a power module performance state recommendation based on the power value and the power target value, wherein the one or more performance state recommendations include the power module performance state recommendation.

8. The method of claim 7, further comprising comparing, by the power optimizer module:
the power value of the at least one of the one or more IP agents; and
the power target value of the one or more target values, wherein the power module performance state recommendation is further based on the comparison.

9. The method of claim 8, further comprising generating, by the power optimizer module, at least one of:
a lower bound power value comprising a minimum power parameter for the at least one of the one or more IP agents; or
an upper bound power value comprising a maximum power parameter for the at least one of the one or more IP agents, wherein:
the lower bound power value is based on the power target value;
the upper bound power value is based on the power target value; and
the comparison of the power value and the power target value is based on at least one of the lower bound power value or the upper bound power value.

10. The method of claim 4, wherein the one or more modules further comprise:
the power optimizer module; and
the efficiency optimizer module, the method further comprising:
receiving, by the power optimizer module, the power value of the at least one of the one or more IP agents;
receiving, by the power optimizer module, a power target value of the one or more target values, the power target value based on the power value of the at least one of the one or more IP agents;
generating, by the power optimizer module, a power module performance state recommendation based on the power value and the power target value, wherein the one or more performance state recommendations include the power module performance state recommendation;
receiving, by the efficiency optimizer module, the power module performance state recommendation;
receiving, by the efficiency optimizer module, the performance module performance state recommendation;
generating, by the efficiency optimizer module, an efficiency module performance state recommendation based on the power module performance state recommendation and the performance module performance state recommendation, wherein:
the one or more performance state recommendations include the efficiency module performance state recommendation; and
the including of the performance module performance state recommendation in the one or more performance state recommendations comprises the including of the efficiency module performance state recommendation in the one or more performance state recommendations.

11. The method of claim 10, further comprising comparing, by the efficiency optimizer module:
the power module performance state recommendation; and
the performance module performance state recommendation, wherein the efficiency module performance state recommendation is further based on the comparison.

12. A system-on-chip (SoC) comprising:
one or more processors;
a policy coordinator;
one or more processing modules;
one or more intellectual property (IP) agents; and
a memory storing instructions that, when accessed by the one or more processors, cause the one or more processors to:
receive, from the policy coordinator, one or more target values, the one or more target values based on one or more IP parameters of the one or more IP agents, the one or more IP parameters based on one or more IP performance states of the one or more IP agents;
receive, from the one or more processing modules, one or more performance state recommendations, the one or more performance state recommendations configured to alter the one or more IP performance states;
generate, based on the one or more target values and the one or more performance state recommendations, a performance state change command, the performance state change command configured to change the one or more IP performance states of the one or more IP agents; and
output the performance state change command to the one or more IP agents.

13. The SoC of claim 12, wherein the one or more processing modules comprise at least one of:
a performance optimizer module;
a power optimizer module;
a thermal controller module;
an efficiency optimizer module; or
a trend monitor module.

14. The SoC of claim 13, wherein the one or more IP parameters comprise at least one of a performance value of at least one of the one or more IP agents, a power value of the at least one of the one or more IP agents, or a temperature value of the at least one of the one or more IP agents.

15. The SoC of claim 14, wherein the one or more modules comprises the performance optimizer module, wherein the instructions further cause the one or more processors to:
receive, by the performance optimizer module, the performance value of the at least one of the one or more IP agents;
receive, by the performance optimizer module, a performance target value of the one or more target values, the performance target value based on the performance value of the at least one of the one or more IP agents; and
generate, by the performance optimizer module, a performance module performance state recommendation based on the performance value and the performance target value, wherein the one or more performance state recommendations include the performance module performance state recommendation.

16. The SoC of claim 15, wherein the instructions further cause the one or more processors to generate, by the performance optimizer module, a lower bound performance value comprising a minimum performance parameter for the at least one of the one or more IP agents, wherein:
the lower bound performance value is based on the performance target value; and
the comparison of the performance value and the performance target value is further based on the lower bound performance value.

17. A non-transitory, computer-readable medium storing instructions that, when accessed by one or more processors, causes the one or more processors to:
receive, from a policy coordinator, one or more target values, the one or more target values based on one or more intellectual property (IP) parameters of one or more IP agents, the one or more IP parameters based on one or more IP performance states of the one or more IP agents;
receive, from one or more processing modules, one or more performance state recommendations, the one or more performance state recommendations configured to alter the one or more IP performance states;
generate, based on the one or more target values and the one or more performance state recommendations, a performance state change command, the performance state change command configured to change the one or more IP performance states of the one or more IP agents; and
output the performance state change command to the one or more IP agents.

18. The non-transitory, computer-readable medium of claim 17, wherein the one or more processing modules comprise at least one of:
a performance optimizer module;
a power optimizer module;
a thermal controller module;
an efficiency optimizer module; or
a trend monitor module.

19. The non-transitory, computer-readable medium of claim 18, wherein the one or more IP parameters comprise at least one of a performance value of at least one of the one or more IP agents, a power value of the at least one of the one or more IP agents, or a temperature value of the at least one of the one or more IP agents.

20. The non-transitory, computer-readable medium of claim 19, wherein the one or more modules comprises the performance optimizer module and the instructions further cause the one or more processors to:
receive, by the performance optimizer module, the performance value of the at least one of the one or more IP agents;
receive, by the performance optimizer module, a performance target value of the one or more target values, the performance target value based on the performance value of the at least one of the one or more IP agents; and
generate, by the performance optimizer module, a performance module performance state recommendation based on the performance value and the performance target value, wherein the one or more performance state recommendations include the performance module performance state recommendation.
